(19) United States
(12) Patent Application Publication
(10) Pub. No.: US 2026/0098966 A1
(43) Pub. Date: Apr. 9, 2026

(54) REFERENCE STATION SETUP POINT

(71) Applicant: Wirtgen GmbH, Windhagen (DE)

(72) Inventors: Matthias Fritz, Hennef (DE); René Müller, Vettelschoß (DE); Manuel Rossa, Aachen (DE); Michael Troß, Dierdorf (DE); Ruud DeJong, Olney, IL (US)

(21) Appl. No.: 19/348,277

(22) Filed: Oct. 2, 2025

(30) Foreign Application Priority Data
Oct. 7, 2024 (DE) 10 2024 128 793.4

(51) Int. Cl. G01S 19/07

(52) U.S. Cl. CPC G01S 19/071

(57) ABSTRACT

A method for determining a reference station setup point for setting up a reference station includes moving a construction machine to a waypoint. At this waypoint, position data describing the position of a construction machine reference point on the construction machine are determined on the basis of the satellite signals of a global navigation satellite system and the correction signals of a reference station already set up on site in the vicinity of the earthmoving machine. The position data describing the position of the reference station setup point are determined based on the position data describing the position of the construction machine reference point on the construction machine at this waypoint and on the basis of a specified spatial relationship between the construction machine reference point and the point specified as the reference station setup point on the ground surface.

### RELATED APPLICATIONS

The present application claims priority to German Patent Application Ser. No. DE 10 2024 128 793.4, filed Oct. 7, 2024, which is incorporated herein by reference.

### BACKGROUND OF THE DISCLOSURE

The disclosure relates to a method for establishing a reference station setup point for setting up a reference station in the vicinity of a self-propelled construction machine moving on site, which transmits correction signals to a DGNSS rover unit assigned to the self-propelled construction machine, the DGNNS rover unit determining, on the basis of the satellite signals of a global navigation satellite system and the correction signals of a reference station already set up on site at another setup point in the vicinity of the construction machine, position data describing the position of a construction machine reference point on the construction machine in a coordinate system independent of the construction machine. Furthermore, the disclosure relates to a method for determining the position of a construction machine reference point on a construction machine moving on site in a coordinate system independent of the construction machine. The disclosure further relates to a position determination system for determining the position of a construction machine reference point on a self-propelled construction machine in a coordinate system independent of the construction machine, and to a construction machine system comprising a construction machine and a position determination system.

Self-propelled construction machinery refers to all construction machinery that has a working device arranged on a machine frame for erecting structures on a site or for altering the site. Well-known self-propelled construction machines include, for example, road milling machines, stabilizers, recyclers, slipform pavers and road pavers. In road milling machines or recyclers, the working device comprises a milling/cutting drum equipped with milling or cutting tools, by means of which material can be removed from the site within a specified working width. The working device of slipform pavers is a device for forming flowable material, in particular concrete, with which structures of different designs, for example guide walls or traffic islands, can be produced. The known road pavers comprise a paving screed for laying the material for the road surface. Soil compactors such as road rollers have at least one compaction device, in particular a compaction drum, for compacting the subsoil.

In the following, a reference station setup point to be established is understood to mean a setup point to be defined at which a reference station is to be set up in the vicinity of a self-propelled construction machine that is to move, or is moving, along a specified path on site. A specified path does not mean that the construction machine must drive autonomously. The construction machine can also be controlled by the machine operator. A reference station setup point to be established must be distinguished from an already established reference station setup point that has already been established, for example, during the planning stage and at which a reference station has already been set up. The already established reference station setup points are referred to as specified reference station setup points. A current reference station setup point is understood to be a single setup point at which a reference station has been deployed. The positions of the specified reference station setup points can be stored as position data in a memory as a position data set, in order to be available for the construction project. Another reference station setup point is understood to mean an already determined reference station setup point.

### DESCRIPTION OF THE PRIOR ART

During the construction of structures on the ground surface or during the alteration of site, high demands are placed on the precision of the construction work. In the control of self-propelled construction machines, the aim is therefore increasingly to relieve the machine operator, who is burdened with a multitude of tasks during construction work. Accordingly, known self-propelled construction machines use position determination systems that determine the position of a reference point on the self-propelled construction machine in a coordinate system independent of the construction machine.

The term GPS (Global Positioning System) is used to describe a position determination system that is based on the evaluation of the signal propagation times of signals from several satellites. The abbreviation GPS is used today colloquially, and sometimes even in technical language, as a generic term or pars pro toto for all satellite navigation systems, which are correctly subsumed under the abbreviation GNSS (Global Navigation (al) Satellite System) (Wikipedia: GPS). The term DGPS (Differential Global Positioning System) or DGNSS is used to describe a method that increases the accuracy of GNSS position determination by emitting correction signals (orbit and time system). DGNSS can also use stationary reference stations, known as base stations, which can be used to determine the actual propagation times of the signals for each satellite very precisely from the deviation between the actual and the received position. The differences between the theoretical and actual signal propagation times are transmitted to the DGNSS receivers, which correct their position using these correction signals (Wikipedia: DGPS). In the following, a GPS rover unit or GNSS rover unit is also understood to mean a DGPS or DGNSS rover unit or vice versa, the terms (D) GPS and (D) GNSS being used synonymously in this context.

DE 197 56 676 C1 (U.S. Pat. No. 6,371,566) discloses a road milling machine which comprises a DGNSS for position determination. The construction machine comprises a DGNSS rover unit for receiving satellite signals of a global navigation satellite system and correction signals of a reference station, the DGNSS rover unit being configured such that, on the basis of the satellite signals and the correction signals, position data describing the position of a reference point on the construction machine are determined in a coordinate system independent of the construction machine.

The reference station for transmitting the correction signals to the DGNSS rover unit is set up in the vicinity of the construction machine in order to increase the accuracy of position determination. When the construction machine moves across the site, the reference station must be relocated, since the range for a radio connection between the DGNSS rover unit and the reference station is limited, and the accuracy of the position determination decreases as the distance between the rover unit and the reference station increases.

A DGNSS requires that the exact position of the reference station on site is known. The exact position of the reference station is also called the actual reference station position. The actual reference station position can be determined using conventional surveying methods. In practice, the reference station is set up at specific reference station setup points on site, which have been previously established during site planning and whose position data are known. These specified position data are entered manually into the reference station by means of an input unit during construction site setup. Re-entry of data is required whenever the reference station is relocated or another reference station is set up. In practice, this procedure proves to be not only time-consuming but also error-prone, since the correct position data must be entered at the relevant setup point. The determination of the exact coordinates of the reference station set up on site and the transfer of these coordinates into a storage unit of the reference station is hereinafter referred to as initialization of a reference station.

A position determination system for determining the position of a reference point on a self-propelled construction machine is known from DE 10 2022 124 484 A1 (U.S. 2024/103179), which has a DGNSS rover unit for receiving satellite signals from a global navigation satellite system and correction signals from a reference station. The reference station is configured such that it can determine its own reference station position. However, since the reference station position determined by the reference station itself is inaccurate, the actual reference station position is communicated to the reference station through an initialization.

The operating principle of the known position determination system is based on the fact that the reference station is set up at specific locations whose position is known. The locations where the reference station is to be set up when the machine moves along a given path, for example along the roadway to be worked on, are established during construction site planning in the office. For example, these locations can be suitable markings on the ground surface in the vicinity of the working area of the construction machine,

DE 10 2022 124 484 A1 (U.S. 2024/103179) proposes, in order to initialize the reference station, reading out a position data set describing the specified positions of a reference station from a storage unit and determining the actual reference station position on the basis of a comparison of the specified positions of the reference station with the reference station position determined by the reference station. The specified positions of a reference station are understood to mean the locations on site whose positions are known and at which the reference station is to be set up along the path to be processed. The comparison allows for automated assignment of the relevant coordinate values, so that the coordinate values of the actual position of the reference station can be selected from the position data set without requiring additional input on the construction site. This simplifies initialization and eliminates incorrect input.

In practice, the points on the ground surface previously established in a planning office at which a reference station is to be set up may not prove to be the optimal reference station setup point, or a reference station may have to be set up at a different point on the ground surface. However, surveying a new setup point using a conventional surveying method afterwards is generally laborious in practice.

### SUMMARY OF THE DISCLOSURE

The object of the disclosure is to specify a method for establishing a reference station setup point for setting up a reference station in the vicinity of a self-propelled construction machine moving on site, which method facilitates the setup of a construction site in practice and reduces the risk of incorrect data entry. A further object of the disclosure is to provide a method for determining the position of a construction machine reference point on a construction machine moving on site, which method facilitates the setup of a construction site in practice and reduces the risk of incorrect data entry.

Furthermore, it is an object of the disclosure to provide a position determination system for determining the position of a construction machine reference point on a self-propelled construction machine, which system facilitates the setup of a construction site in practice and reduces the risk of incorrect data input, and to provide a construction machine system comprising a construction machine and a position determination system.

These objects are achieved according to the disclosure with the features of the independent claims. The subject matter of the dependent claims relates to preferred embodiments of the disclosure.

The method according to the disclosure for establishing a reference station setup point is intended for setting up a reference station that transmits correction signals to a DGNSS rover unit assigned to the self-propelled construction machine, the DGNSS rover unit determining, on the basis of the satellite signals of a global navigation satellite system and the correction signals of a reference station already set up on site at another setup point in the vicinity of the construction machine, position data describing the position of a construction machine reference point on the construction machine in a coordinate system independent of the construction machine.

The method according to the disclosure is characterized in that the construction machine is first moved to a waypoint on site, in the vicinity of which a reference station is to be set up. This waypoint does not have to be located on the desired reference station setup point, but may be close to it. At this waypoint, position data describing the position of the construction machine reference point on the construction machine are determined in a coordinate system independent of the construction machine using the DGNSS rover unit on the basis of the satellite signals of a global navigation satellite system and the correction signals of the reference station already set up on site in the vicinity of the earthmoving machine.

A point on the ground surface that is in a specified spatial relationship to the construction machine reference point on the construction machine is then established as the reference station setup point at which the reference station is to be deployed. In this context, establishing of a point on the ground surface is understood to encompass all measures used to signal the location of a point on site. For example, the point on site can be marked either temporarily or permanently using suitable means.

Thereafter, position data describing the position of the reference station setup point are determined in a coordinate system independent of the construction machine on the basis of the position data describing the position of the construction machine reference point on the construction machine at this waypoint and on the basis of the specified spatial relationship between the construction machine reference point on the construction machine and the point established as the reference station setup point on the ground surface.

The position data describing the position of the reference station setup point are then stored in a storage unit. The position data can be read out from the storage unit at any time for further data processing. Consequently, the data are available, in particular, for the initialization of the reference station to be set up at this setup point, without the need for a conventional survey of the point by a geodesist. The determined reference station setup point thus becomes an already established reference station setup point.

In this context, a storage unit is understood to mean any data storage device on which data can be stored and from which the data can be read, for example the known electronic memories (semiconductor memories) and storage media that can be read or written with electronic devices. The storage unit can be part of the construction machine or the reference station, or may be an external memory (cloud storage).

The embodiments of the disclosure described below can comprise one or more of the features or combinations of features mentioned below. A feature designated with an indefinite article can also be present more than once if the indefinite article is not to be understood with an explicit reference to a single use. A designation of features with a number word, for example “first and second,” does not exclude that the number of these features can be greater than the number indicated by the number word. In the description of all the embodiments, the expression “can” is also to be understood as “preferably” or “expediently.”

The method according to the disclosure for establishing a reference station setup point is intended for setting up a reference station in the vicinity of a self-propelled construction machine moving on site. Establishing of the reference station setup point on the ground surface can be carried out by means of a plumb body suspended from a chain or a cord and with a downward-pointing tip, the chain or cord being fastened to the construction machine at a fastening point which is in a specified spatial relationship to the construction machine reference point on the construction machine. The tip of the plumb body then points to the point on the ground surface where the reference station is to be set up. In order to be able to establish the point on site more easily and accurately, the construction machine is preferably lowered from a raised position, in which the tip of the plumb body is above the ground surface, to a lowered position, while the tip of the plumb body points to the reference station setup point, which can be permanently marked using suitable means. The construction machine can be lowered until the tip of the plumb body touches the ground. However, lowering the construction machine is unnecessary if the tip of the plumb body is already directly above the ground surface.

The reference station setup point on the ground surface can also be determined by means of a measuring rod with a downward-pointing tip, the measuring rod being fastened, so as to be displaceable in the direction of its longitudinal axis, to the construction machine at a fastening point which is in a specified spatial relationship to the construction machine reference point on the construction machine. To determine the reference station setup point, the measuring rod can be lowered from a raised position, with the tip of the measuring rod above the ground surface, to a lowered position with the tip of the measuring rod pointing towards the reference station setup point. When the measuring rod is lowered to the ground, its tip can be used to mark the reference station setup point on the ground surface, at least provisionally.

A further alternative is to establish the reference station setup point on the ground surface by means of a laser, the laser being fastened to the construction machine at a fastening point which is in a specified spatial relationship to the construction machine reference point (R) on the construction machine. The laser beam then points to the reference station setup point, which can be permanently marked using suitable means.

The permanent marking of the reference station setup point may be carried out using the known marking elements, in particular with a ground nail. Alternatively or additionally, the surface can be marked with color, for example using spray paint.

The specified spatial relationship in which the reference station setup point is located to the construction machine reference point (R) on the construction machine can be any spatial relationship. In practice, however, the aim is to create the simplest possible spatial relationship. This can be achieved by aligning the construction machine horizontally or parallel to the ground surface in order to determine the reference station setup point on the ground surface.

In the embodiment with the plumb body suspended from a chain or rope, a horizontal alignment of the construction machine proves to be optimal, since in a horizontal alignment the chain or rope forms a right angle with the plumb body and a transverse plane of the machine frame. This results in relatively simple geometric relationships between the construction machine reference point, the fastening point, and the projection of the fastening point onto the ground surface that establishes the reference station setup point.

In the embodiment with the measuring rod, an alignment of the construction machine parallel to the ground surface proves to be optimal, since when aligned parallel to the ground the longitudinal axis of the measuring rod and the ground surface enclose a right angle.

However, if the inclination of the construction machine relative to the horizontal is known, the position data describing the position of the reference station setup point can also be determined without a specific alignment of the construction machine.

The method according to the disclosure for determining the position of a construction machine reference point on a construction machine moving on site in a coordinate system independent of the construction machine provides for supplying a reference station in the vicinity of the construction machine and a DGNSS rover unit which, on the basis of the satellite signals of a global navigation satellite system and correction signals from the reference station set up in the vicinity of the construction machine, determines position data describing the position of a reference point on the construction machine in a coordinate system independent of the construction machine, wherein the correction signals are calculated on the basis of the actual reference station position and the reference station position determined by the reference station.

A DGNSS rover unit is understood to mean a mobile unit that can determine the position of the self-propelled construction machine when the rover unit is assigned to the construction machine. The DGNSS rover unit may comprise several components, for example at least one GPS antenna and a computing and evaluation unit, the GPS antenna being arranged at the construction machine reference point so that the GPS antenna can receive the satellite signals. The DGNSS rover unit can also comprise two GPS antennas to determine not only the position of the construction machine but also its orientation on site.

Furthermore, the method according to the disclosure provides for the determination of a reference station setup point, at which the reference station is to be set up, by the inventive method described above, and for the setup of the reference station at the reference station setup point determined by the method described above, in order to be able to determine the position of the construction machine reference point with high accuracy while the construction machine moves along a specified path.

In practice, the reference station setup points are generally surveyed in advance by a geodesist on site, and the determination of a reference station setup point according to the method according to the disclosure described above is only considered if a new reference point is to be determined during the construction work. In principle, however, it would also be possible to have only the first reference station setup point along the path surveyed by a geodesist and to determine all setup points using the method according to the disclosure. However, in that case, there is the avoidable risk of error propagation.

After the determination of the position of a new reference station setup point in accordance with the method according to the disclosure without renewed surveying, the position of this reference station setup point can be stored in a storage unit together with the other specified positions measured by a geodesist. Reinitialization of the reference station to be newly set up can then be determined on the basis of a comparison of position data stored in a storage unit, which describe the positions of specified reference station setup points, with the reference station position determined by the reference station according to the method described in DE 10 2022 124 484 A1 (U.S. 2024/103179).

The position determination system according to the disclosure for determining the position of a construction machine reference point on a self-propelled construction machine in a coordinate system independent of the construction machine comprises a DGNSS rover unit to be assigned to the construction machine and a reference station to be set up in the vicinity of the construction machine.

The DGNSS rover unit is configured to receive the satellite signals of a global navigation satellite system and correction signals from a reference station to be set up within the vicinity of the self-propelled construction machine and, on the basis of the satellite signals and the correction signals, to determine position data describing the position of a construction machine reference point on the construction machine in a coordinate system independent of the construction machine.

The reference station to be set up in the vicinity of the construction machine is configured to transmit correction signals to the DGNSS rover unit, the correction signals being calculated on the basis of the actual reference station position and the reference station position determined by the reference station.

The position determination system according to the disclosure is characterized in that the position determination system comprises a reference station setup point establishing device which is configured such that a point on the ground surface, which is in a specified spatial relationship to the construction machine reference point on the construction machine, can be set as a reference station setup point. The reference station setup point establishing device permits subsequent definition of a reference station setup point without renewed surveying by a geodesist.

The reference station setup point establishing device may comprise a plumb body suspended from a chain or cord with a downward-pointing tip, or a measuring rod with a downward-pointing tip, or a laser. In addition, the reference station setup point establishing device may comprise a marking element for marking the reference station setup point, in particular a ground nail.

An embodiment of the position determination system according to the disclosure provides that the DGNSS rover unit is configured such that position data describing the position of the reference station setup point are determined in a coordinate system independent of the construction machine on the basis of position data describing the position of the construction machine reference point on the construction machine at a waypoint and on the basis of the specified spatial relationship between the construction machine reference point on the construction machine and the point established as the reference station setup point on the ground surface. To establish and determine the position of the reference station setup point, the construction machine only needs to be moved to a location near the desired point.

The DGNSS rover unit can be configured such that the position of the reference station setup point, which is in a specified spatial relationship to the construction machine reference point on the construction machine, is determined on the basis of the satellite signals and the correction signals of a reference station already deployed in the vicinity of the construction machine.

A further embodiment of the position determination system according to the disclosure provides that position data describing the positions of specified reference station setup points are stored in a storage unit, and that the position determination system is configured such that, for the initialization of a reference station to be set up at a reference station setup point, the position data describing the positions of the reference station setup points are read out from the storage unit, and the actual reference station position is determined on the basis of a comparison of the position data describing the specified reference station setup points with the reference station position determined by the reference station.

The comparison allows for automated assignment of the relevant coordinate values, so that the coordinate values of the actual position of the reference station can be selected from the position data set without requiring additional input on the construction site. This simplifies initialization and eliminates incorrect input. In this context, a comparison is understood as relating the individual positions in order to be able to determine deviations between the known, exact positions and the measured, inaccurate positions, so that the values can be correctly assigned to one another. The comparison may be carried out on the basis of known computational operations or algorithms.

The construction machine system according to the disclosure comprises a construction machine and the position determination system according to the disclosure. The construction machine system is therefore understood to mean an arrangement of construction machinery and position determination system.

The reference station setup point establishing device may comprise:
a plumb body with a downward-pointing tip suspended from a chain or cord, the chain or cord being fastened to a fastening point provided on the construction machine, which fastening point is in a specified spatial relationship to the construction machine reference point on the construction machine, or
a measuring rod with a downward-pointing tip, the measuring rod being fastened, so as to be displaceable in the direction of its longitudinal axis, to the construction machine at a fastening point which is in a specified spatial relationship to the construction machine reference point (R) on the construction machine (I), or
a laser, the laser being fastened to the construction machine at a fastening point which is in a specified spatial relationship to the construction machine reference point (R) on the construction machine.

In principle, any device whose spatial relationship to the construction machine reference point on the construction machine can be determined is suitable as a reference station setup point establishing device. This also includes devices that are movable relative to the construction machine, for example pivotable booms, provided that the relative movement with respect to the construction machine reference point can be detected.

Since the dimensions of the construction machine are known, the spatial relationship between the construction machine reference point and the position of the reference station setup point can also be determined. This specified spatial relationship can be determined on the basis of the distance from the fastening point from the construction machine reference point in an X-direction of a Cartesian coordinate system, the distance from the fastening point from the construction machine reference point in a Y-direction of the Cartesian coordinate system, and the distance from the fastening point from the ground surface in a Z-direction of the Cartesian coordinate system. The Cartesian coordinate system is preferably a coordinate system referenced to the construction machine, whereby the Y-axis can extend in the longitudinal direction and the X-axis in the transverse direction of the construction machine. This coordinate system can be oriented such that the distance in an X and Y-direction does not depend on the height of the construction machine reference point above the ground.

In a further embodiment of the construction machine system according to the disclosure, the construction machine comprises a machine frame with a downwardly open drum housing in which a working drum for working the ground is arranged, the drum housing being closed at least on one side by an edge guard which is adjustable on the machine frame between a position raised relative to the ground surface and a position lowered onto the ground surface, in which the edge guard rests with its lower edge on the ground surface. The construction machine comprises a measuring device that records the height position of the edge guard. In this embodiment, the DGNSS rover unit is configured to determine the distance from the fastening point from the ground surface in the Z-direction of the Cartesian coordinate system on the basis of the height information of the measuring device. Such determination of the distance is particularly advantageous in the embodiment with the laser. In the embodiment with the chain or rope and the plumb body, it is also possible in principle to determine the distance in the Z-direction solely on the basis of the known dimensions of the construction machine and the length of the chain or rope and the plumb body, when the construction machine is lowered until the tip of the plumb body meets the ground surface. In the embodiment with the measuring rod, the measuring rod can be moved and/or the construction machine lowered until the tip of the measuring rod meets the ground surface.

### BRIEF DESCRIPTION OF THE DRAWINGS

Multiple exemplary embodiments of the disclosure will be explained in more detail below with reference to the drawings.

In the drawings:

FIG. 1 is a side view of a self-propelled construction machine,

FIG. 2 is a plan view of the self-propelled construction machine of FIG. 1,

FIG. 3 shows an embodiment of the position determination system for determining the position of a reference point on the construction machine,

FIG. 4 shows the self-propelled construction machine moving along a path, with the reference station set up at a first position,

FIG. 5 shows the self-propelled construction machine moving along a path, with the reference station set up at a second position,

FIG. 6 shows the self-propelled construction machine moving along a path, with the reference station set up at a third position,

FIG. 7 shows the self-propelled construction machine moving along a path, with the reference station set up at a fourth position,

FIG. 8 shows a further embodiment of the position determination system for determining the position of a reference point on the construction machine,

FIG. 9 shows a further embodiment of the position determination system for determining the position of a reference point on the construction machine,

FIG. 10 is a rear view of an exemplary embodiment of the construction machine, in which the reference station setup point establishing device is shown,

FIG. 11 is a side view of the construction machine of FIG. 10,

FIG. 12 shows another exemplary embodiment of the reference station setup point establishing device comprising a laser,

FIG. 13A shows another exemplary embodiment of the reference station setup point establishing device comprising a measuring rod, wherein the measuring rod is in the raised position and

FIG. 13B shows another exemplary embodiment of the reference station setup point establishing device comprising a measuring rod, wherein the measuring rod is in the lowered position.

### DETAILED DESCRIPTION

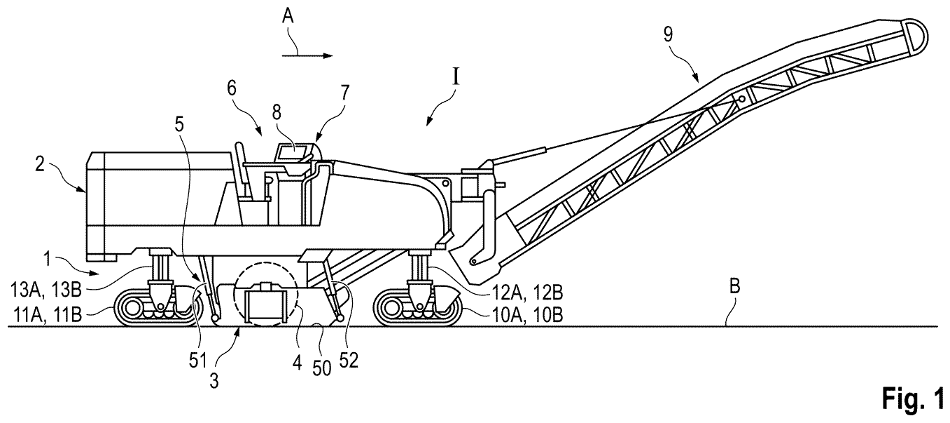

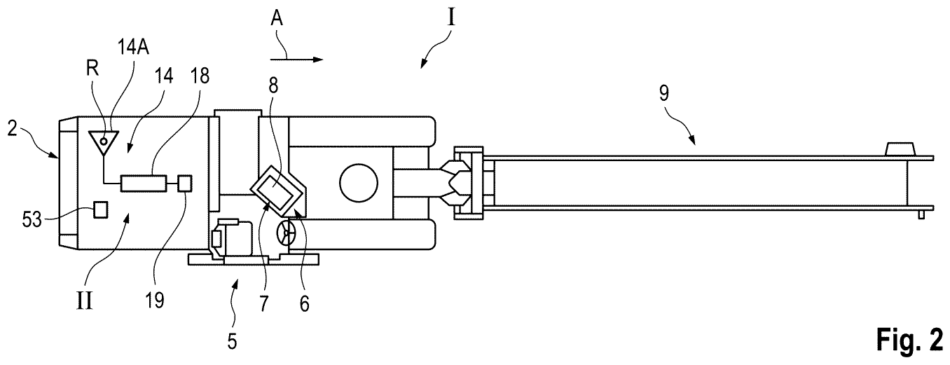

FIGS. 1 and 2 show, in side view and plan view, a road milling machine for milling road surfaces as an example of a self-propelled construction machine, the road milling machine being a front-loader road milling machine.

The construction machine I comprises a machine frame 2 carried by a chassis 1, on which a working device 3 is arranged by means of which the work required for the construction project can be carried out. The working device 3 comprises a milling drum 4, shown only schematically in FIG. 1, which is arranged in a downwardly open milling drum housing 5. The milling drum housing 5 is closed on both sides by an edge guard 50, which is adjustable on the machine frame 2 between a raised position relative to the ground surface B and a lowered position relative to the ground surface. During milling operations, the edge guard 50 rests with its lower edge on the ground surface B. Two piston-cylinder arrangements 51, 52 are provided for adjusting the edge guard 50. In addition, a measuring device (not shown in FIGS. 1 and 2) for detecting the height position of the edge guard 50 is provided, which may comprise measuring sensors assigned to the piston-cylinder arrangements 51, 52 and providing height information.

Above the milling drum housing 5, the operator's platform 6 with a control panel 7 for the machine operator is arranged on the machine frame. The control panel 7 may comprise a touchscreen 8 on which control fields (buttons) are displayed. The milled material is removed by a conveyor device 9.

The self-propelled construction machine I may comprise, in the working direction A, a front left undercarriage 10A, a front right undercarriage 10B, a rear left undercarriage 11A, and a rear right undercarriage 11B, which are associated with, in the working direction A, a front left and right lifting device 12A, 12B and rear left and right lifting device 13A, 13B, respectively, so that, by retracting or extending the lifting devices, the height and inclination of the machine frame 2 relative to the ground surface B can be changed.

The construction machine I is controlled by a control device 53, shown only schematically, as a function of construction machine position data that describe the position of a reference point R on the construction machine in a coordinate system (X, Y, Z) independent of the construction machine. For determining the position of a reference point R on the construction machine I, a position determination system II is provided, the structure and function of which are described in detail below.

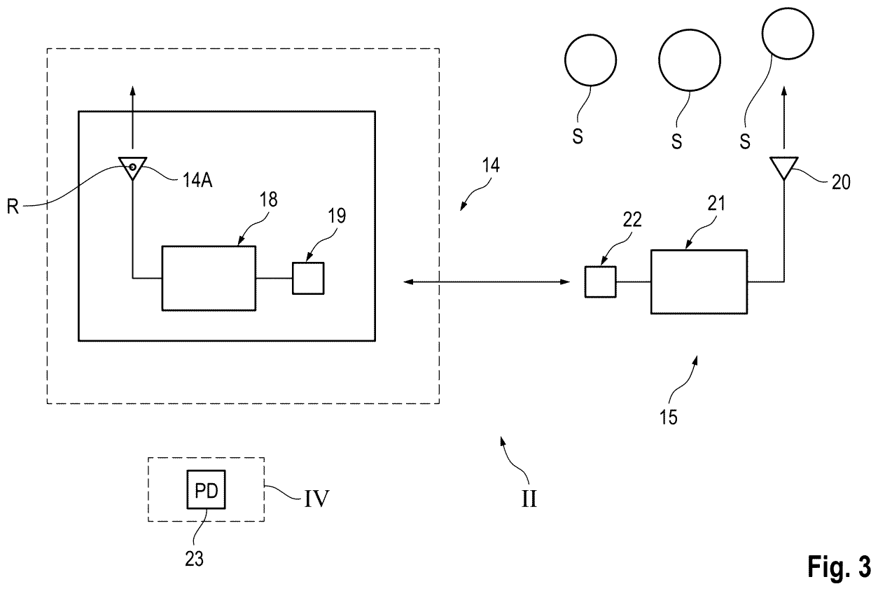

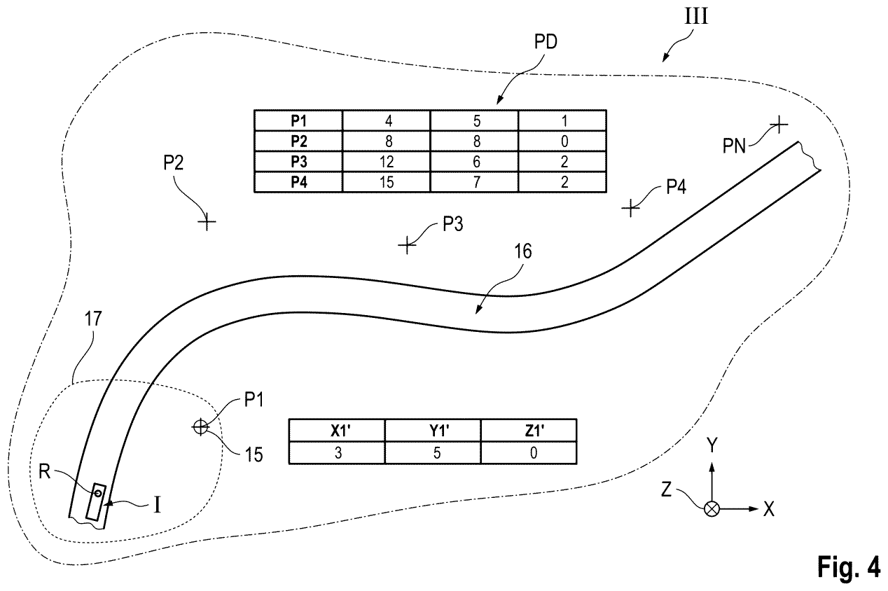

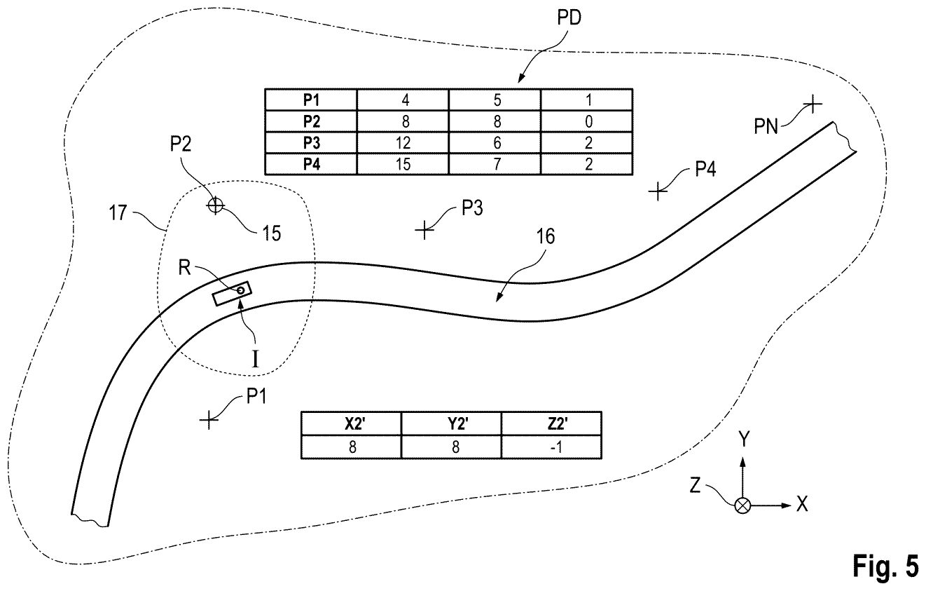

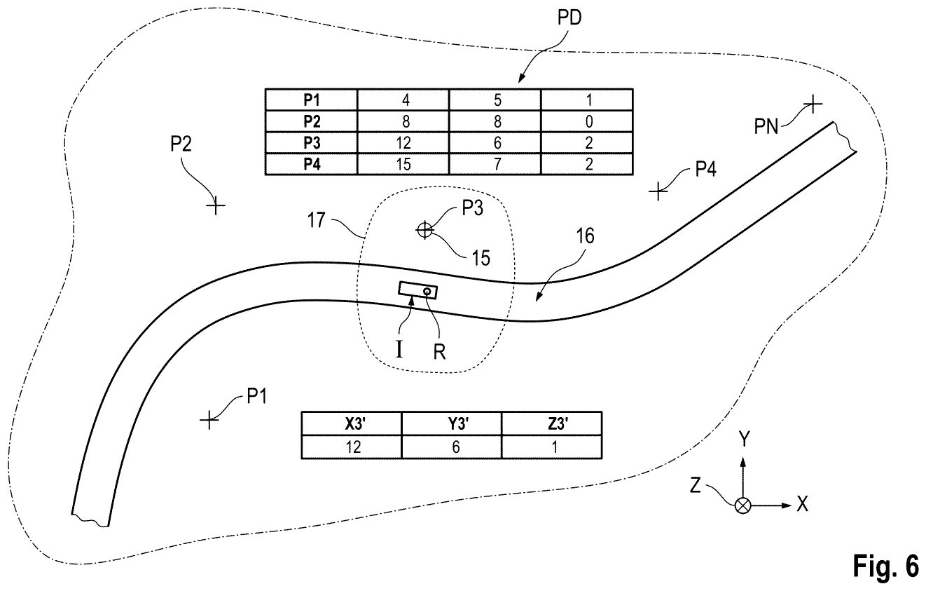

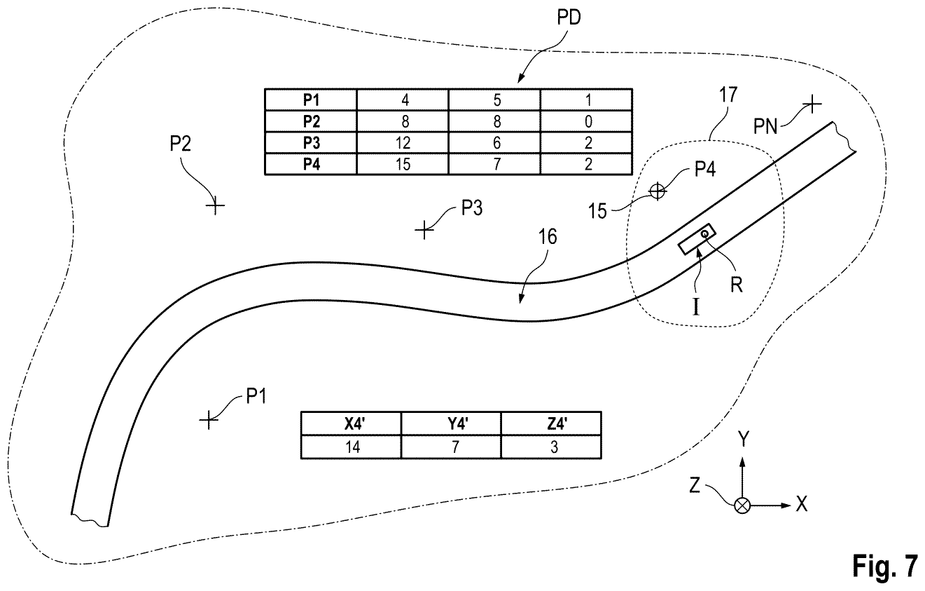

FIG. 3 shows a simplified schematic representation of the position determination system II, which comprises a GNSS rover unit 14 and a reference station 15. The GNSS rover unit 14 is provided on the construction machine I, so that the GNSS rover unit 14 moves with the construction machine I across the site, while the reference station 15 is set up in the vicinity of the construction machine. The arrangement of construction machine I and position determination system II is also referred to as construction machine system III (FIGS. 4 to 7).

FIGS. 4 to 7 show the movement of the construction machine I, in particular a road milling machine, over the site along a specified path 16, in particular a road. In FIGS. 4 to 7, the possible setup locations for the reference station, at which the reference station 15 can be deployed, are marked with a cross. These setup locations are generally specified during planning of the construction site and can be marked with suitable marking elements that can be easily found on site. Hereinafter, these locations are also referred to as reference station setup points.

As the construction machine I moves along the path 16, the reference station 15 is relocated several times so that the reference station always remains within a radius 17 of the construction machine I, which does not exceed a certain radius that essentially depends on both the construction machine I, the reference station 15 and the local conditions. The positions P1 (X1, Y1, Z1), P2 (X2, Y2, Z2), P3 (X3, Y3, Z3), P4 (X4, Y4, Z4), PN (XN, YN, ZN) of the reference station setup points are described by coordinate values in a coordinate system independent of the construction machine. These coordinate values can be X, Y, Z coordinate values of a Cartesian coordinate system. For illustration, the X, Y, Z coordinate values for the individual positions P1 (X1, Y1, Z1), P2 (X2, Y2, Z2), P3 (X3, Y3, Z3), P4 (X4, Y4, Z4), PN (XN, YN, ZN) are each shown in a table. These coordinate values form a position data set PD, which describes the specified positions of the reference station setup points.

The DGNSS rover unit 14 comprises at least one GPS antenna 14A, which is arranged at the reference point R of the construction machine I, a computing and evaluation unit 18, and a bidirectional transmitting and receiving unit 19 (FIG. 3). The reference station 15 comprises a GPS antenna 20, a computing and evaluation unit 21, and a bidirectional transmitting and receiving unit 22. The DGNSS rover unit 14 and reference station 15 communicate via the transmitting and receiving units 19, 22, which are intended to represent the known transmission links that can operate according to the known transmission methods (RF transmitter/receiver, WLAN, Bluetooth, etc.).

The GPS antenna 20 of the reference station 15 receives the satellite signals from several satellites of at least one satellite navigation system S, the computing and evaluation unit 21 thereof being configured such that the position P1′ (X1′, Y1′, Z1′), P2′ (X2′, Y2′, Z2′), P3′ (X3′, Y3′, Z3′), P4′ (X4′, Y4′, Z4′), PN′ (XN′, YN′, ZN′) of the reference station 15 is determined from the satellite signals with an accuracy corresponding to the GPS system. This position is referred to as the reference station position P1′, P2′, P3′, P4′ determined, measured, or received by the reference station. The computing and evaluation unit 21 of the reference station 15 is further configured such that correction signals are calculated according to the known methods on the basis of the actual reference station position P1 (X1, Y1, Z1), P2 (X2, Y2, Z2), P3 (X3, Y3, Z3), P4 (X4, Y4, Z4), PN (XN, YN, ZN) and the measured reference station position P1′ (X1′, Y1′, Z1′), P2′ (X2′, Y2′, Z2′), P3 (X3′, Y3′, Z3′), P4 (X4′, Y4′, Z4′), PN′ (XN′, YN′, ZN′), which requires that, in addition to the measured reference station position, the actual reference station position is also known. This corresponds to the known position of the specified reference station setup point.

The DGNSS rover unit 14 likewise receives the satellite signals from several satellites of a global navigation satellite system S via the GPS antenna 14A. In addition, the DGNSS rover unit 14 receives the correction signals from the reference station 15 via the transmitting and receiving unit 19. The computing and evaluation unit 18 of the GNSS rover unit 14 is configured such that, according to the known methods, on the basis of the satellite signals and the correction signals, position data describing the (exact) position of the reference point R on the construction machine I are determined with a higher accuracy in the coordinate system (X, Y, Z) independent of the construction machine.

The computing and evaluation unit 18 of the DGNSS rover unit 14 and the computing and evaluation unit 21 of reference station 15 may comprise, for example, a general processor, a digital signal processor (DSP) for continuously processing digital signals, a microprocessor, an application-specific integrated circuit (ASIC), a field-programmable gate array (FPGA), or
other integrated circuits (IC) or hardware components. A data processing program (software) can run on the hardware components. A combination of the various components is also possible.

FIG. 3 shows an embodiment in which the computing and evaluation unit 18 of the DGNSS rover unit 14 interacts with an external storage unit 23, in which the position data set PD describing the specified positions of the reference station setup points of the reference stations is stored. This storage unit 23 may also be the data memory of a server unit IV (file server), wherein the computing and evaluation unit 18 forms a network with the file server, which can be implemented, for example, via a wireless connection, such as WLAN. However, data exchange with the external storage unit may also take place via the Internet.

The computing and evaluation unit 18 of the DGNSS rover unit 14 and the computing and evaluation unit 21 of the reference station 15 are configured such that the following method steps are carried out to initialize the reference station.

The reference station 15 set up at the positions P1 (X1, Y1, Z1), P2 (X2, Y2, Z2), P3 (X3, Y3, Z3), P4 (X4, Y4, Z4), PN (XN, YN, ZN) receives the satellite signals S and transmits the measured position data P1′ (X1′, Y1′, Z1′), P2′ (X2′, Y2′, Z2′), P3 (X3′, Y3′, Z3′), P4 (X4′, Y4′, Z4′), PN′ (XN′, YN′, ZN′) by means of the transmitting and receiving unit 22 to the DGNSS rover unit 15, which position data describe the reference station position determined by the reference station (FIG. 3, FIGS. 4 to 7). These position data are received by the DGNSS rover unit via the transmitting and receiving unit 19. The DGNSS rover unit 14 reads the position data set PD describing the specified positions of the reference station 15 from the external storage unit 23. On the basis of a comparison of the specified positions of the reference station P1 (X1, Y1, Z1), P2 (X2, Y2, Z2), P3 (X3, Y3, Z3), P4 (X4, Y4, Z4), PN (XN, YN, ZN) with the reference station position P1′ (X1′, Y1′, Z1′), P2′ (X2′, Y2′, Z2′), P3 (X3′, Y3′, Z3′), P4 (X4′, Y4′, Z4′), PN′ (XN′, YN′, ZN′) determined by the reference station 15, the DGNSS rover unit 14 determines the actual reference station position P1 (X1, Y1, Z1), P2 (X2, Y2, Z2), P3 (X3, Y3, Z3), P4 (X4, Y4, Z4), PN (XN, YN, ZN) and transmits position data describing the actual reference station position by means of the transmitting and receiving unit 19 to the reference station 15, which receives these position data by means of the transmitting and receiving unit 22. Once the reference station 15 knows its actual position, its computing and evaluation unit 22 calculates the correction signals, which it transmits to the DGNSS rover unit 15. The computing and evaluation unit 18 of the DGNSS rover unit 14 then calculates, on the basis of the satellite signals and the correction signals, the construction machine position data describing the exact position of the reference point R on the construction machine.

For the selection of the associated coordinate values, the computing and evaluation unit 18 of the DGNSS rover unit 14 compares the received reference station position P1′ (X1′, Y1′, Z1′), P2′ (X2′, Y2′, Z2′), P3 (X3′, Y3′, Z3′), P4 (X4′, Y4′, Z4′), PN′ (XN′, YN′, ZN′) of the reference station 15 with the specified reference station positions P1 (X1, Y1, Z1), P2 (X2, Y2, Z2), P3 (X3, Y3, Z3), P4 (X4, Y4, Z4), PN (XN, YN, ZN) from the position data set PD that are assigned to the individual setup locations. This will be described using the following exemplary embodiment.

FIG. 3 shows the reference station 15 set up at position P1. The measured coordinate values (X1′, Y1′, Z1′) of the reference station position are (3, 5, 0). The computing and evaluation unit 18 of the DGNSS rover unit 14 determines the deviations of the coordinate values (X1=4, Y1=5, Z1=1), (X2=8, Y2=8, Z2=0), (X3=12, Y3=6, Z3=2, (X4=15, Y4=7, Z4=2) of the specified positions of the reference station with the reference station position (3, 5, 0) determined by the reference station 14. It can be seen that the deviation of the coordinate values is the smallest for the position P1. Therefore, the position with the coordinate values (4, 5, 1) is assumed to be the actual position of the reference station 15. For example, a mean deviation can be calculated from the coordinate values as follows.

Position P1

$$Absolute value of 3 - 4 = 1$$

$$Absolute value of 5 - 5 = 0$$

$$Absolute value of 0 - 1 = 1$$

$$Mean deviation : ( 1 + 0 + 1 ) / 3 = 2 / 3 [ smallest mean deviation ]$$

Position P2

$$Absolute value of 3 - 8 = 5$$

$$Absolute value of 5 - 8 = 3$$

$$Absolute value of 0 - 0 = 0$$

$$Mean deviation : ( 5 + 3 + 0 ) / 3 = 8 / 3$$

Position P3

$$Absolute value of 3 - 12 = 9$$

$$Absolute value of 5 - 6 = 1$$

$$Absolute value of 0 - 2 = 2$$

$$Mean deviation : ( 9 + 1 + 2 ) / 3 = 4$$

Position P4

$$Absolute value of 3 - 15 = 12$$

$$Absolute value of 5 - 7 = 2$$

$$Absolute value of 0 - 2 = 2$$

$$Mean deviation : ( 12 + 2 + 2 ) / 3 = 16 / 3$$

The computing and evaluation unit 18 of the DGNSS rover unit 14 selects the position P1 with the coordinate values (4, 5, 1), since for position P1 the mean deviation 2/3 is the smallest. However, for example, the distances (paths) in the plane (two-dimensional) or in space (three-dimensional) between the positions in the coordinate system can also be calculated, and the position with the smallest distance can be selected.

The computing and evaluation unit 18 of the DGNSS rover unit 14 can also be configured such that the specified position of the reference station is assumed to be the actual position of the reference station 15, the coordinate values of which deviate from the coordinate values of the reference station position determined by the reference station by a value that is less than or equal to a specified limit value, or deviate by values that are less than or equal to specified limit values. For example, the absolute value of the difference between the individual coordinate values can be calculated as follows and compared, for example, with the limit value 1:

Position P1 (limit value 1)

$$Absolute value of 3 - 4 = 1$$

$$Absolute value of 5 - 5 = 0$$

$$Absolute value of 0 - 1 = 1$$

$$1 \leq 1 \qquad 0 \leq 1 \qquad 1 \leq 1$$

Position P2 (limit value 1)

$$Absolute value of 3 - 8 = 5$$

$$Absolute value of 5 - 8 = 3$$

$$Absolute value of 0 - 0 = 0$$

$$5 > 1 \qquad 3 > 1 \qquad 0 \leq 1$$

Position P3 (limit value 1)

$$Absolute value of 3 - 12 = 9$$

$$Absolute value of 5 - 6 = 1$$

$$Absolute value of 0 - 2 = 2$$

$$9 > 1 \qquad 1 \leq 1 \qquad 2 > 1$$

Position P4 (limit value 1)

$$Absolute value of 3 - 15 = 12$$

$$Absolute value of 5 - 7 = 2$$

$$Absolute value of 0 - 2 = 2$$

$$12 > 1 \qquad 2 > 1 \qquad 2 > 1$$

The computing and evaluation unit 18 of the DGNSS rover unit 14 selects the position P1 with the coordinate values (4, 5, 1) because the coordinate values for position 1 are less than or equal to the limit value 1.

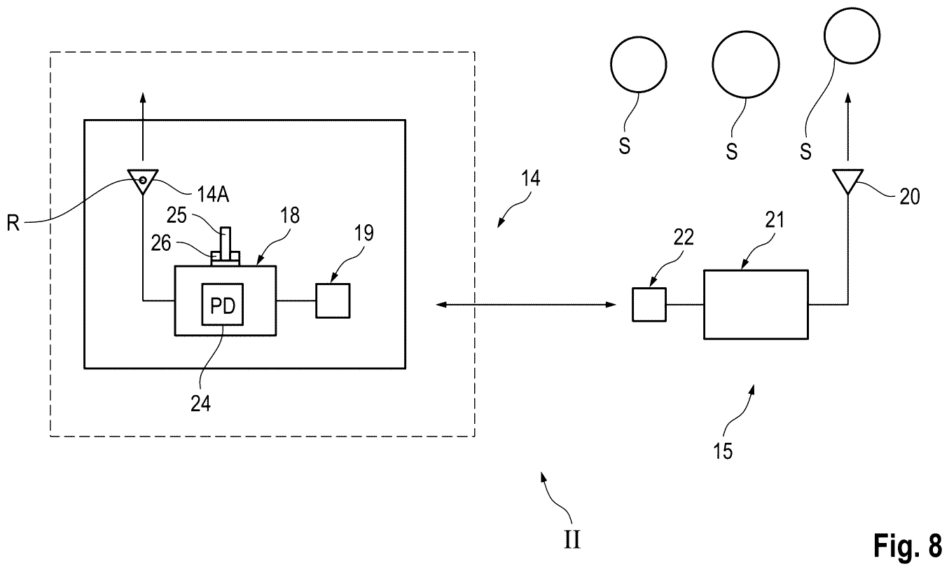

FIG. 8 shows an embodiment that differs from the embodiment described with reference to FIG. 3 in that the computing and evaluation unit 18 of the DGNSS rover unit 14 comprises an internal storage unit 24 in which the position data set PD is stored. The corresponding components are provided with the same reference signs in the drawings. The computing and evaluation unit 18 comprises a data interface 26 via which the position data set PD can be read in from a mobile data carrier, for example from a USB stick 25, into the internal storage unit 24. For reading in the data, the USB stick 25 is inserted into a USB port 26 provided on the DGNSS rover unit 14. Consequently, the position data set PD is not read from an external storage unit 23, for example a file server (FIG. 3), but from an internal storage unit 24.

In an advantageous embodiment, the position data set PD is transmitted from an external storage unit 23 to an internal storage unit 24 of the construction machine I via a wireless connection before the start of construction work, as explained with reference to FIG. 3. As a result, the position data set PD is available throughout the entire construction process, independently of a data connection to a central server unit, and can be easily transmitted to the construction machine I in advance of the work.

The computing and evaluation unit 18 of the DGNSS rover unit 14 and the computing and evaluation unit 21 of the reference station 15 can also be configured such that the following method steps are carried out to initialize the reference station.

The computing and evaluation unit 18 of the DGNSS rover unit 14 reads the position data set PD describing the specified positions P1 (X1, Y1, Z1), P2 (X2, Y2, Z2), P3 (X3, Y3, Z3), P4 (X4, Y4, Z4), PN (XN, YN, ZN) of the reference station from the external storage unit 23 (FIG. 3) or the internal storage unit 24 of the DGNSS rover unit 14 (FIG. 8) and transmits the position data set PD to the reference station 15, wherein the reference station receives these position data. In this embodiment, the reference station 15 then determines the actual reference station position based on a comparison of the specified positions of the reference station with the reference station position determined by the reference station, as described with reference to FIG. 3.

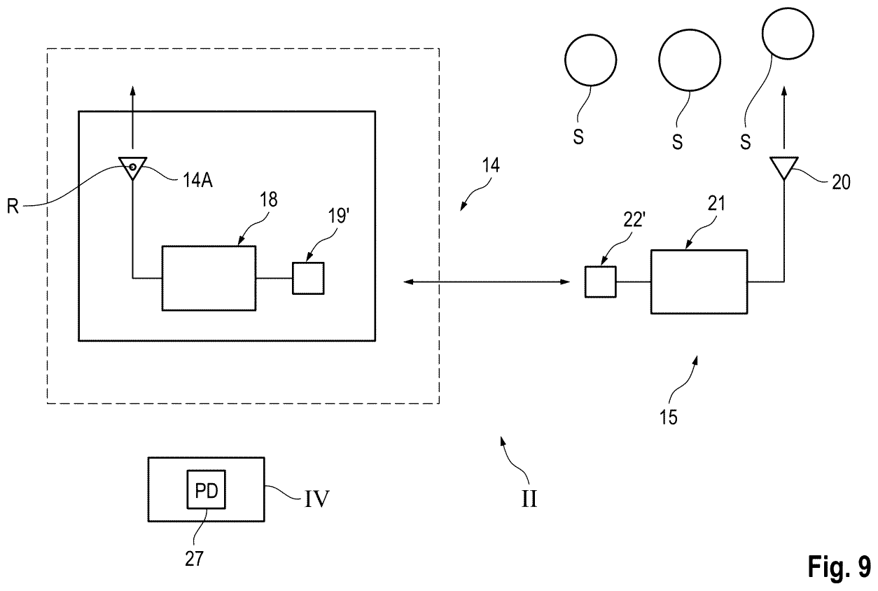

FIG. 9 shows a further embodiment in which a server unit IV has a storage unit 27 to which the position data set PD is stored. The server unit IV forms a network with the reference station 15, for example a WLAN, or the reference station 15 communicates with the server unit IV via the Internet. The computing and evaluation unit 21 of the reference station 15 and the server unit S are configured such that the reference station 15 transmits the reference station positions P1′ (X1′, Y1′, Z1′), P2′ (X2′, Y2′, Z2′), P3 (X3′, Y3′, Z3′), P4 (X4′, Y4′, Z4′), PN′ (XN′, YN′, ZN′) determined by the reference station 15 to the server unit IV, and these position data are received by the server unit S, wherein, in contrast to the embodiment shown in FIG. 3, it is not the DGNSS rover unit 14 but the server unit S that determines the actual reference station position on the basis of a comparison of the specified positions of the reference station with the reference station position determined by the reference station, and transmits the position data P1 (X1, Y1, Z1), P2 (X2, Y2, Z2), P3 (X3, Y3, Z3), P4 (X4, Y4, Z4), PN (XN, YN, ZN) describing the actual reference station position to the reference station 15, which receives this position data. In this embodiment, bidirectional data transmission between DGNSS rover unit 14 and reference station 15 is not required. Therefore, the reference station 15 has only one transmitting unit 22′ and the DGNSS rover unit 14 has only one receiving unit 19′. The reference station 15 is further configured to exchange data with the server unit IV.

However, it is also possible for the server unit IV to transmit a position data set PD describing the specified positions of the reference station to the reference station 15 and for the reference station 15 to receive this position data set, wherein the reference station 15 then determines the actual reference station position P (X, Y,Z) on the basis of a comparison of the actual positions P1 (X1,Y1,Z1), P2 (X2,Y2,Z2), P3 (X3,Y3,Z3), P4 (X4, Y4,Z4), PN (XN, YN,ZN) of the reference station with the reference station position P1′ (X1′, Y1′,Z1′), P2′ (X2′, Y2′, Z2′), P3 (X3′,Y3′,Z3′), P4 (X4′, Y4′,Z4′), PN′ (XN′, YN′, ZN′) determined by the reference station, as described with reference to FIG. 3.

In principle, the data storage device (USB stick 25) can also be connected to the reference station in order to transmit the position data set PD to the reference station 15.

Determining the position of a construction machine reference point on the construction machine, as described above and known from DE 10 2022 124 484 A1 (U.S. 2024/103179), requires the definition of reference station setup points during construction site planning and the surveying of the reference points on site by a geodesist.

The present disclosure relates to the case where a reference station setup point is to be determined without the involvement of a geodesist. This may arise if a reference station setup point established during planning subsequently turns out to be unsuitable, for example due to shadowing by buildings or trees, or due to an excessive distance to another reference station setup point. In the event of an interruption to construction work, it may be necessary to establish a new reference station setup point within the vicinity of the construction machine. For this purpose, the position determination system according to the disclosure has a reference station setup point establishing device, the structure and function of which are described in detail below. In FIG. 4, a reference station setup point that is to be newly established within the vicinity of the construction machine is designated by the reference sign PN.

It should be noted that no coordinates need to be established in advance for the point PN. The position can be freely selected according to the conditions prevailing on the construction site. The coordinates of this freely selected position are then determined by the method according to the disclosure as described above.

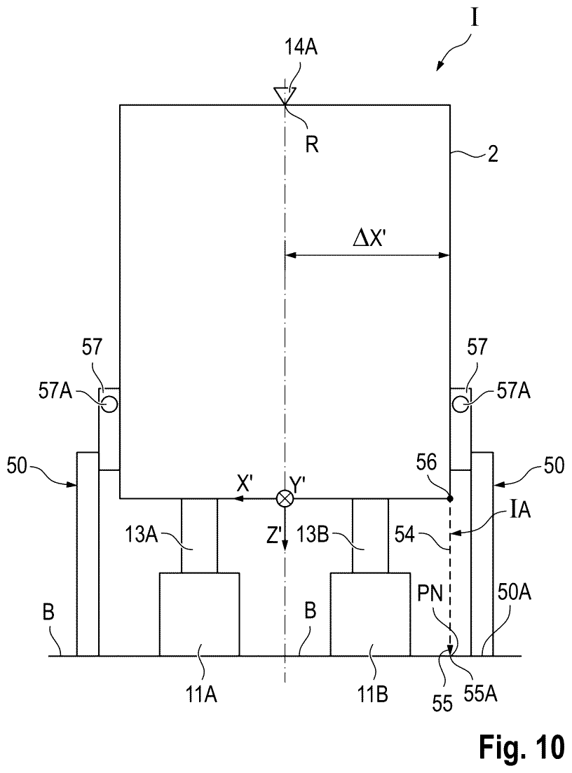

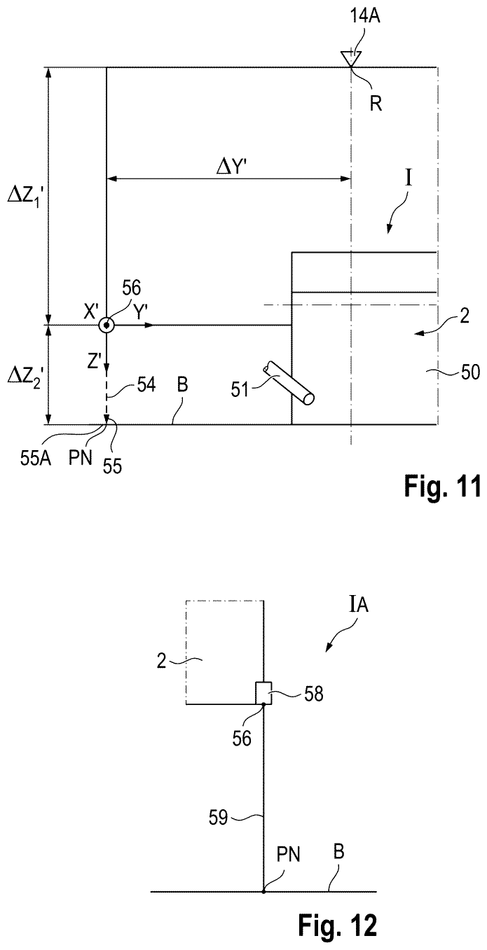

FIG. 10 shows, in a simplified schematic representation, a rear view and FIG. 11 a side view of an embodiment of a construction machine I according to the disclosure, which comprises the reference station setup point establishing device IA according to the disclosure. The parts of the construction machine according to the disclosure that correspond to those of the construction machine of FIGS. 1 and 2 are provided with the same reference signs.

FIGS. 10 and 11 show the machine frame 2 of the construction machine I, supported on the ground B by the left and right undercarriages 11A, 11B in the working direction, and the edge guard 50 provided on the left and right sides in the position lowered to the ground. One of the piston/cylinder arrangements 51 for adjusting the height of the edge guard 50 is shown in FIG. 11. The GPS antenna 14A of the DGNSS rover unit 14 and the construction machine reference point R are located on the top of the construction machine I on its longitudinal axis. In FIG. 10, the measuring device 57 for determining the height position of the left-side and right-side edge guard 50 is shown only schematically. The measuring device 57 comprises a sensor 57A which provides height information. The measuring device can, for example, comprise a sensor that detects the stroke position of the pistons of the piston/cylinder arrangements 51, 52.

In the present embodiment, the reference station setup point establishing device IA comprises a plumb body 55 suspended from a chain 54 or a cord and having a downward-pointing tip 55A. The upper end of the chain 54 or cord is fastened to the machine frame 2. In the present embodiment, the fastening point 56 of the chain 54 or cord is located at the lower rear corner of the machine frame 2, so that the chain 54 or cord with the plumb body 55 is clearly visible. The length of the chain 54 or cord is dimensioned such that the tip 55A of the plumb body 55 reaches the ground B when the construction machine I is in a corresponding height position. FIG. 10 shows the position of the construction machine I in which the tip 55A of the plumb body 55 just touches the ground B. In this position, the tip 55A of the plumb body 5 marks a reference station setup point P1 (X1, Y1, Z1), P2 (X2, Y2, Z2), P3 (X3, Y3, Z3), P4 (X4, Y4, Z4), PN (XN, YN, ZN) on the ground surface.

From FIGS. 10 and 11, it can be seen that the reference station setup point P1 (X1, Y1, Z1), P2 (X2, Y2, Z2), P3 (X3, Y3, Z3), P4 (X4, Y4, Z4), PN (XN, YN, ZN), i.e., the point marked by the tip of the plumb body on the ground surface, is in a spatial relationship to the construction machine reference point R which is specified by the dimensions of the construction machine I and its height position. FIGS. 10 and 11 show a Cartesian coordinate system (X′, Y′, Z′) whose origin lies in the longitudinal center plane of the machine frame 2 on the longitudinal axis of the construction machine. If the position of the construction machine reference point R is known, the position of the reference station setup point P1 (X1, Y1, Z1), P2 (X2, Y2, Z2), P3 (X3, Y3, Z3), P4 (X4, Y4, Z4), PN (XN, YN, ZN) can be determined from the known distance ΔX′ in the X′ direction of the coordinate system (X′, Y′, Z′) and the known distance ΔY′ in the Y′ direction of the coordinate system (X′, Y′, Z′) as well as the distance ΔZ′=ΔZ′1+ΔZ′2 in the Z-direction of the coordinate system (X′, Y′, Z′), where the distance ΔZ′1 in the Z-direction of the coordinate system (X′, Y′, Z′) is obtained from the dimensions of the construction machine I or the arrangement of the fastening point 56 on the machine frame 2, and the distance ΔZ₂ in the Z-direction is obtained from the distance between the machine frame 2 or the fastening point 56 and the surface of the ground B.

In the present embodiment, the distance ΔZ′1 in the Z-direction of the coordinate system (X′, Y′, Z′) is obtained from the height information of the measuring device 57 when, in the orientation of the construction machine I shown in FIGS. 10 and 11, the lower edge 50A of the left-side or right-side edge guard 50 rests on the ground B, as shown in FIGS. 10 and 11. The height information for determining the position of the reference station setup point can, in principle, be provided by any measuring device that determines the distance between the machine frame and the ground surface. Such measuring devices are already present in self-propelled construction machines, for example for leveling. A measuring device can be dispensed with if the length of the chain 54 is known and the tip 55A of the plumb body 55 touches the ground B, so that the distance ΔZ′1 can be inferred.

The DGNSS rover unit 14 of the position determination system II according to the disclosure is configured such that position data describing the position of a new reference station setup point PN in a coordinate system (X′, Y′, Z′) independent of the construction machine on the basis of position data describing the position of the construction machine reference point on the construction machine I at a waypoint and on the basis of the specified spatial relationship between the construction machine reference point R and the point set as the reference station setup point P1 (X1, Y1, Z1), P2 (X2, Y2, Z2), P3 (X3, Y3, Z3), P4 (X4, Y4, Z4), PN (XN, YN, ZN) on the ground surface.

In the present embodiment, in order to establish the new reference station setup point PN, the construction machine is moved to a waypoint in the vicinity of which a reference station is to be set up. In the present embodiment, the construction machine is moved to a waypoint at which the tip 55A of the plumb body 55 points to the point on site at which the reference station is to be set up. At this point, the construction machine is aligned by retracting or extending the lifting devices 12A, 12B and 13A, 13B such that the machine frame 2 lies in a horizontal plane, so that the chain 54 or the rope forms a right angle with the horizontal plane, i.e., the fastening point 56 of the chain 54 or rope lies exactly above the reference station setup point PN (FIGS. 10 and 11). The lifting devices 12A, 12B and 13A, 13B can be retracted far enough until the tip 55A of the plumb body 55 touches the surface of the ground B, so that the reference station setup point can be precisely established. The left-side and right-side edge guard 50 rests on the ground B. The point at which the tip 55A of the plumb body 55 contacts the ground B is then permanently marked with a marking element, in particular with a ground nail.

The DGNSS rover unit 14 determines, on the basis of the satellite signals of a global navigation satellite system S and the correction signals of the reference station already set up on site at another setup point in the vicinity of the construction machine, for example, the reference station set up at the reference station setup point P3, the position data describing the position of the construction machine reference point R on the construction machine I in a coordinate system (X′, Y′, Z′) independent of the construction machine. In addition, the DGNSS rover unit 14 determines the position data describing the position of the new reference station setup point PN in a coordinate system (X′, Y′, Z′) independent of the construction machine on the basis of the position data describing the position of the construction machine reference point R on the construction machine I at the waypoint, as well as the distance ΔX in the X-direction of the coordinate system (X′, Y′, Z′), the distance ΔY′ in the Y′-direction of the coordinate system (X′, Y′, Z′), and the distance ΔZ′=ΔZ′1+ΔZ′2 in the Z-direction of the coordinate system (X′, Y′, Z′). The distance ΔZ′ 2 in the Z′-direction of the coordinate system (X, Y, Z) is calculated by the DGNSS rover unit 14 from the height information of the measuring device 57. The values required to calculate the coordinates can be read from a storage unit. The position data describing the position of the reference station setup point P1 (X1, Y1, Z1), P2 (X2, Y2, Z2), P3 (X3, Y3, Z3), P4 (X4, Y4, Z4), PN (XN, YN, ZN) are then stored in a storage unit, for example the storage unit 23 (FIG. 3) or the storage unit 24 (FIG. 8) or the storage unit 27 (FIG. 9), so that the newly generated point on site is available to further applications.

A reference station 15 can then be set up at the new reference station setup point PN, which has been surveyed “by the construction machine itself” without the involvement of a geodesist. When the reference station is set up at the new reference station setup point PN, the initialization of the reference station can be carried out by entering or reading the position of the reference station setup point determined “by the construction machine itself” into the reference station.

In the present embodiment, the position of the reference station setup point determined “by the construction machine itself” is stored together with the specified positions P1 (X1, Y1, Z1), P2 (X2, Y2, Z2), P3 (X3, Y3, Z3), P4 (X4, Y4, Z4), PN (XN, YN, ZN) of the other reference stations in the storage unit 23, 24 or 27. Consequently, this position is also available to the system for further data processing.

The position determination system II is configured such that, for initialization of the reference station set up at the new reference station setup point, the position data set PD describing the positions of the reference station setup points is read from the storage unit 23, 24 or 27 and the actual reference station position is determined on the basis of a comparison of the specified positions of the reference station setup points (P1 (X1, Y1, Z1), P2 (X2, Y2, Z2), P3 (X3, Y3, Z3), P4 (X4, Y4, Z4), PN (XN, YN, ZN)) with the reference station position P1′ (X1′, Y1′, Z1′), P2′ (X2′, Y2′, Z2′), P3 (X3′, Y3′, Z3′), P4 (X4′, Y4′, Z4′), PN′ (XN′, YN′, ZN′) determined by the reference station. Initialization of the new reference station can therefore be carried out in the same way as the initialization of the reference stations already set up, using the procedure described above.

FIG. 12 shows an alternative embodiment of the reference station setup point establishing device IA, which differs from the reference station setup point establishing device described above in that, instead of the plumb body suspended on a chain or rope, a laser 58 is provided, which is fastened to the fastening point 56 located on the machine frame 2 of the construction machine I, the fastening point being in a specified spatial relationship to the construction machine reference point (R) on the construction machine. In this embodiment, the laser beam 59 strikes the ground surface at the reference station setup point PN at a right angle.

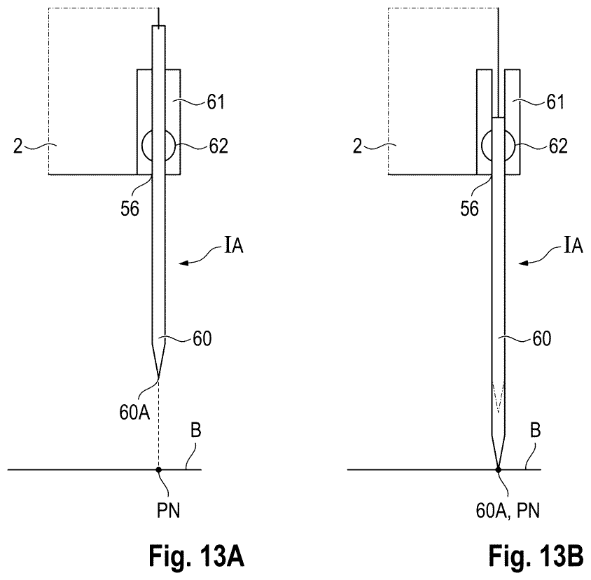

FIGS. 13A and 13B show a further alternative embodiment in which the reference station setup point establishing device IA comprises a measuring rod 60, which is fastened to the fastening point 56 on the machine frame 2 of the construction machine I so as to be displaceable in the direction of its longitudinal axis. For the longitudinally displaceable fastening of the measuring rod 60, the reference station setup point establishing device IA has a schematically illustrated linear guide 61. In addition, a measuring device 62 is provided which detects the height position of the measuring rod 60, with a measuring sensor that provides height information of the measuring rod 60. The measuring rod 60 is fastened to the machine frame 2 in such a way that its longitudinal axis forms a right angle with the ground B when the machine frame 2 is aligned horizontally. To establish the reference station setup point, the measuring rod is moved downwards from the position shown in FIG. 13A to the position shown in FIG. 13B until its tip 60A hits the ground B. With the height information from the measuring device 62 and the known dimensions of the construction machine I, all the values are available again to determine the exact position of the reference station setup point using the method described above.

Aligning the machine frame parallel to the ground and/or horizontally is generally the preferred procedure for determining the reference station setup point. If the machine has not been deliberately aligned, the inclination of the machine frame relative to the ground surface or to the horizontal can be determined using various sensors, for example sensors that detect the lifting position of the lifting columns 12A/B, 13A/B, or inclination sensors. With the determined inclination and the known dimensions of the machine frame, it is then also possible to determine the spatial relationship between the reference station setup point establishing device IA, for example the fastening point of the chain or rope, and the construction machine reference point R, and to carry out the method according to the disclosure.

1-15. (canceled)

16. A method of establishing a reference station setup point for setting up, in a vicinity of a self-propelled construction machine moving on a site, a reference station that transmits correction signals to a DGNSS rover unit associated with the self-propelled construction machine, the DGNSS rover unit determining, on the basis of satellite signals of a global navigation satellite system and correction signals of a previous reference station already set up on the site at another setup point in the vicinity of the construction machine, position data describing the position of a construction machine reference point on the construction machine in a coordinate system independent of the construction machine, the method comprising:
moving the construction machine to a waypoint on site, in the vicinity of which the reference station is to be set up, and determining position data describing the position of the construction machine reference point on the construction machine in the coordinate system independent of the construction machine using the DGNSS rover unit at the waypoint, on the basis of the satellite signals of the global navigation satellite system and the correction signals of the reference station already set up on site in the vicinity of the construction machine;
establishing a point on a ground surface that is in a specified spatial relationship to the construction machine reference point on the construction machine as the reference station setup point at which the reference station is to be set up;
determining position data describing the position of the reference station setup point in the coordinate system independent of the construction machine on the basis of the position data describing the position of the construction machine reference point on the construction machine at the waypoint and on the basis of the specified spatial relationship between the construction machine reference point on the construction machine and the point established as the reference station setup point on the ground surface; and
storing the position data describing the position of the reference station setup point in a storage unit.

17. The method of claim 16, wherein:
the establishing of the point on the ground surface includes suspending a plumb body from a chain or cord, the plumb body including a downward-pointing tip, the chain or cord being fastened to the construction machine at a fastening point which is in a specified spatial relationship to the construction machine reference point on the construction machine.

18. The method of claim 17, wherein:
the establishing of the point on the ground surface further includes lowering the construction machine from a raised position in which the tip of the plumb body is above the ground surface, into a lowered position, while the tip of the plumb body points to the reference station setup point.

19. The method of claim 16, wherein:
the establishing of the point on the ground surface includes lowering a measuring rod from a raised position in which a tip of the measuring rod is above the ground surface, into a lowered position while the tip of the measuring rod points to the reference station setup point, the measuring rod being fastened to the construction machine at a fastening point so as to be displaceable in a direction of its longitudinal axis, which fastening point is in a specified spatial relationship to the construction machine reference point on the construction machine.

20. The method of claim 16, wherein:
the establishing of the point on the ground surface is carried out using a laser fastened to the construction machine at a fastening point which is in a specified spatial relationship to the construction machine reference point on the construction machine.

21. The method of claim 16, wherein:
the establishing of the point on the ground surface is performed with the construction machine aligned horizontally and/or parallel to the ground surface.

22. The method of claim 16, further comprising:
marking the reference station setup point on the ground surface with a marking element.

23. The method of claim 22, wherein:
the marking element is a ground nail.

24. The method of claim 16, further comprising:
deploying the reference station at the reference station setup point on the ground surface; and
determining position data describing the position of the reference point on the construction machine in the coordinate system independent of the construction machine, using the DGNSS rover unit on the basis of the satellite signals of the global navigation satellite system and correction signals from the reference station at the reference station setup point on the ground surface.

25. The method of claim 24, further comprising:
initializing an actual reference station position of the reference station on a basis of a comparison of position data stored in the storage unit describing positions of specified reference station setup points, with a reference station position determined by the reference station.

26. A position determination system for determining a position of a construction machine reference point on a self-propelled construction machine in a coordinate system independent of the construction machine, comprising:
a reference station configured to transmit correction signals calculated on a basis of an actual reference station position and a reference station position determined by the reference station;
a DGNSS rover unit configured to receive satellite signals of a global navigation satellite system and the correction signals from the reference station, the DGNSS rover unit being configured such that, on the basis of the satellite signals and the correction signals, position data describing a position of a construction machine reference point on the construction machine are determined in the coordinate system independent of the construction machine; and
a reference station setup point establishing device configured such that a point on a ground surface which is in a specified spatial relationship to the construction machine reference point on the construction machine can be established as a reference station setup point.

27. The position determination system of claim 26, wherein:
the DGNSS rover unit is configured such that position data describing the position of the reference station setup point are determined in the coordinate system independent of the construction machine on the basis of position data describing the position of the construction machine reference point on the construction machine and on the basis of the specified spatial relationship between the construction machine reference point on the construction machine and the point defined as the reference station setup point on the ground surface.

28. The position determination system of claim 27, further comprising:
a storage unit including position data describing positions of specified reference station setup points stored in the storage unit, wherein the position determination system is configured such that, for an initialization of the reference station to be set up at the reference station setup point, the position data describing the positions of the specified reference station setup points are read out from the storage unit, and an actual reference station position is determined on the basis of a comparison of the position data describing the positions of the specified reference station setup points with a reference station position determined by the reference station.

29. The position determination system of claim 28, wherein:
the DGNSS rover unit is configured such that the position data describing the position of the reference station setup point, which have been determined on the basis of position data describing the position of the construction machine reference point on the construction machine and on the basis of the specified spatial relationship between the construction machine reference point on the construction machine and the point defined as the reference station setup point on the ground surface, are stored in the storage unit.

30. The position determination system of claim 26, wherein:
the reference station setup point establishing device comprises a plumb body suspended from a chain or a cord with a downward-pointing tip, the chain or cord being fastened to a fastening point provided on the construction machine, which fastening point is in a specified spatial relationship to the construction machine reference point on the construction machine.

31. The position determination system of claim 26, wherein:
the reference station setup point establishing device comprises a measuring rod with a downward-pointing tip, the measuring rod being fastened to the construction machine at a fastening point so as to be displaceable in a direction of a longitudinal axis of the measuring rod, the fastening point being in a specified spatial relationship to the construction machine reference point on the construction machine.

32. The position determination system of claim 26, wherein:
the reference station setup point establishing device comprises a laser fastened to the construction machine at a fastening point which is in a specified spatial relationship to the construction machine reference point on the construction machine.

33. The position determination system of claim 26, wherein:
the reference station setup point establishing device comprises a marking element for marking the reference station setup point on the ground surface.

34. The position determination system of claim 26, wherein:
the reference station setup point establishing device is fastened to the construction machine at a fastening point which is in a specified spatial relationship to the construction machine reference point on the construction machine; and
the specified spatial relationship between the construction machine reference point and the position of the reference station setup point is determined on the basis of a distance from the fastening point to the construction machine reference point (R) in an X′-direction of a Cartesian coordinate system (X′, Y′, Z′) and a distance from the fastening point to the construction machine reference point in a Y-direction of the Cartesian coordinate system (X′, Y′, Z′) and a distance from the fastening point from the ground surface in a Z′-direction of the Cartesian coordinate system.

35. The position determination system of claim 34, wherein:
the construction machine comprises a machine frame with a downwardly open drum housing, in which a working drum for working the ground surface is arranged, the drum housing being closed at least on one side by an edge guard which is adjustable on the machine frame between a position raised relative to the ground surface and a position lowered onto the ground surface, in which position the edge guard rests with its lower edge on the ground surface, and in that the construction machine has a measuring device which detects a height position of the edge guard, wherein the DGNSS rover unit is configured such that the distance from the fastening point to the ground surface in the Z-direction of the Cartesian coordinate system is determined on the basis of height information of the measuring device.
